(19) United States
(12) Patent Application Publication
(10) Pub. No.: US 2023/0378852 A1
(43) Pub. Date: Nov. 23, 2023

(54) INTEGRATED AXLE DRIVE AND MOTOR VEHICLE

(71) Applicant: Vitesco Technologies Germany GMBH, Regensburg (DE)

(72) Inventors: Andy Holland, Berlin (DE); Lennart Leopold, Berlin (DE); Christoph Heukenroth, Berlin (DE); Henrique Ramos Pereira, Nürnberg (DE); Lucas Schmieder, Berlin (DE)

(73) Assignee: Vitesco Technologies Germany GMBH, Regensberg (DE)

(21) Appl. No.: 18/364,861

(22) Filed: Aug. 3, 2023

Related U.S. Application Data
(63) Continuation of application No. PCT/EP2022/052945, filed on Feb. 8, 2022.

(30) Foreign Application Priority Data
Feb. 12, 2021 (DE) 10 2021 201 358.9

(51) Int. Cl. H02K 11/225; H02K 5/15; H02K 11/25; H02K 11/33

(52) U.S. Cl. CPC H02K 11/225; H02K 5/15; H02K 11/25; H02K 11/33; B60K 1/00

(57) ABSTRACT

An integrated axle drive for an at least partially electrically driven motor vehicle, having an electric machine which has a rotor which is mounted so as to be rotatable about a rotor axis, a transmission which is coupled to the electric machine, an inverter which is arranged on the transmission and which is electrically conductively connected to the electric machine, wherein the transmission is arranged between the electric machine and the inverter, a multi-part rotor position sensor, having a sensor target which is arranged and/or formed on the rotor in a rotationally fixed manner and a sensor board which is arranged, with an air gap to the sensor target, on an end shield of the electric machine, wherein the end shield carrying the sensor board is arranged between the transmission and the rotor, and the sensor board is electrically conductively connected to the inverter.

### CROSS-REFERENCE TO RELATED APPLICATIONS

This application claims priority to PCT Application PCT/EP2022/052945, filed Feb. 8, 2022, which claims priority to German Patent Application No. DE 10 2021 201 358.9, filed Feb. 12, 2021. The disclosures of the above applications are incorporated herein by reference.

### FIELD OF THE INVENTION

The invention relates to an integrated axle drive for an at least partially electrically driven motor vehicle. The axle drive includes at least an electric machine, a transmission and an inverter, wherein the transmission is arranged and/or configured between the electric machine and the inverter. A rotor position sensor is arranged between the electric machine and the transmission and is electrically conductively connected to the inverter. The invention also relates to a motor vehicle with the axle drive according to the invention.

### BACKGROUND OF THE INVENTION

Integrated axle drives are known in principle. The known axle drives generally have an electric machine, a transmission and an inverter. The inverter is arranged and/or oriented in a tangential direction to the rotor axis of the electric machine. It is also known that such integrated axle drives have a rotor position sensor in order to detect the rotational position of the rotor. In this case, provision is made for the rotor position sensor to be arranged on that side of the electric machine which faces away from the transmission. This has the advantage that the rotor position sensor can be positioned and arranged in a simple manner. The cable of the rotor position sensor is guided out of the housing of the electric machine and electrically conductively connected to the inverter. A disadvantage of the known arrangement of the rotor position sensor is that the rotor position sensor has to be adapted in dependence on the power of the electric machine, which can be determined, inter alia, by the rotor length of the electric machine. In particular, the cable lengths of the rotor position sensor to the inverter then vary depending on the selected rotor length. Due to the increased cable length, which is guided in part outside the housing, the rotor position sensor or the signal line is exposed to increased electromagnetic influences.

### SUMMARY OF THE INVENTION

It is an object of the invention to provide an integrated axle drive with a rotor position sensor for an at least partially electrically driven motor vehicle, wherein the arrangement and/or design of the rotor position sensor may exhibit increased robustness in relation to electromagnetic influences.

This object is achieved by the subject matter described herein. The disclosure describes developments and/or refinements of the invention. In this case, each feature may represent an aspect of the invention both individually and in combination, provided nothing to the contrary is explicitly stated in the description.

According to the invention, an integrated axle drive for an at least partially electrically driven motor vehicle is provided, having an electric machine which has a rotor which is mounted so as to be rotatable about a rotor axis, a transmission which is coupled to the electric machine, an inverter which is arranged on the transmission and which is electrically conductively connected to the electric machine, wherein the transmission is arranged between the electric machine and the inverter, a multi-part rotor position sensor, having a sensor target which is arranged and/or formed on the rotor in a rotationally fixed manner and a sensor board which is arranged, with an air gap to the sensor target, on an end shield of the electric machine, wherein the end shield carrying the sensor board is arranged between the transmission and the rotor, and the sensor board is electrically conductively connected to the inverter.

In other words, an aspect of the invention is that an integrated axle drive for an at least partially electrically driven motor vehicle is provided. The axle drive is thus in an embodiment arranged in the drive train of a motor vehicle. It is configured and/or designed to drive the motor vehicle.

The integrated axle drive has an electric machine, a transmission and an inverter. The electric machine includes at least one rotor which is mounted so as to be rotatable about a rotor axis, wherein the electric machine, i.e., a rotor shaft of the rotor, is mechanically coupled to the transmission. The inverter is arranged on a side of the transmission facing away from the electric machine and is electrically conductively connected to the electric machine.

Furthermore, provision is made for the electric machine to have a rotor position sensor. The rotor position sensor, such as an inductive sensor, is of multi-part form and includes a sensor target which is arranged and/or formed on the rotor in a rotationally fixed manner and a sensor board which is arranged, with an air gap to the sensor target, on an end shield of the electric machine. The end shield carrying the sensor board is arranged between the transmission and the rotor or between the transmission and the electric machine. In other words, the end shield may be in the form of an intermediate wall between the transmission and the electric machine. The end shield may thus be part of a housing of the electric machine and/or part of a housing of the transmission. The sensor board is electrically conductively connected to the inverter. Connecting the sensor board and the inverter over a short path makes it possible to reduce the electromagnetic influences on the electrically conductive connection of the rotor position sensor, such that the sensor exhibits increased accuracy. In addition, the selected position of the rotor position sensor between the electric machine and the transmission has no influence on rotor length scaling in order to increase or reduce the power of the electric machine. In this way, the selected arrangement of the rotor position sensor reduces the interface influence when the power of the electric machine is changed.

The sensor target has, in a circumferential direction of the rotor, a plurality of portions and/or projections which are directed inward or outward in a radial direction. The portions and/or projections may be arranged and/or formed on a circular ring.

An embodiment of the invention is that a cable for the electrically conductive connection of the inverter to the sensor board is guided through a transmission housing of the transmission. In other words, the cable is not guided outside of the multi-part housing of the integrated axle drive, but rather on a direct path through the transmission housing or its walls. In this way, the cable, i.e., the signal line between the inverter and the sensor board, exhibits increased robustness in relation to external electromagnetic influences.

In this context, a refinement of the invention is that a cable leadthrough which is separated from the actual transmission mount in a media-tight manner and through which the cable, for example the signal line, is guided between the inverter and the sensor board is formed within the transmission housing. In other words, the cable or the signal line is not guided through the actual oil-filled transmission chamber having the transmission gear wheels, but rather through a cable leadthrough which is separated from the transmission chamber in a media-tight manner. In this way, the external influences on the cable or the signal line and its connector are reduced, as a result of which the longevity of the electrical connection between the inverter and the sensor board are increased. In addition, the costs of the cable may be reduced, since it is possible to dispense with an increased media-tightness of the cable and/or the connector.

Another embodiment of the invention is that the sensor board is of media-tight form. In other words, the sensor board is formed in such a way that it has increased resistance to aggressive ambient media, such as cooling media or oils. Media-tightness of the sensor board is achieved by enclosing or by encapsulation of the sensor board. Encapsulation is also referred to as overmolding. In the case of encapsulation, the sensor board and any electrical components arranged thereon are at least partially, or completely, encapsulated with a plastic, such as a thermoplastic or thermosetting plastic. The plastic may be a carbon-fiber-reinforced plastic (CFRP) or carbon fiber reinforced plastic (CRP).

The sensor board may be arranged on the end shield in such a way that it is fixed in a positionally secure manner. An embodiment of the invention is that the sensor board is arranged on the end shield in a force-fitting and/or materially bonded manner. A force-fitting connection should be understood to include that the sensor board is arranged on the end shield of the electric machine and/or on the intermediate wall between the electric machine and the transmission by way of at least one screw connection, bolt connection and/or rivet connection. A materially bonded connection should be understood to include an adhesive connection or a bonded connection. The adhesive may be a one-component adhesive or a multi-component adhesive.

The sensor target is arranged on the rotor in a rotationally fixed manner. In a refinement of the invention, provision is made for the rotor to have a rotor shaft, and for the sensor target to be arranged on the rotor shaft in a rotationally fixed manner. The rotor shaft may be in the form of a continuous shaft, a rotor hollow shaft or an assembled rotor shaft. It is conceivable for the sensor target to be arranged on an outer circumference of the rotor shaft in a rotationally fixed manner. For example, the sensor target may be seated on the rotor shaft with an interference fit. In this way, the sensor target may subsequently be arranged on the rotor in a simple manner.

In a development of the invention, provision is made for the rotor to have at least one end disk, and for the sensor target to be arranged on the end disk or to be an integral part of the end disk. A laminated core of the rotor is braced in a longitudinal direction of the rotor by way of the end disks. The end disks thus delimit the laminated core of the rotor in its axial direction. The sensor target may be arranged or formed on a side of the end disk facing away from the laminated core, that is to say a side of the end disk facing toward the end shield or the transmission. In this way, the sensor target is arranged in a space-saving manner.

It is conceivable for the sensor target to be arranged on the end disk in a force-fitting and/or materially bonded manner. A force-fitting connection of the sensor target on the end disk should be understood to refer to a screw connection, bolt connection and/or rivet connection. A materially bonded connection should be understood to refer to a bonded connection of the sensor target on the end disk.

As an alternative to the materially bonded and/or force-fitting arrangement of the sensor target on the end disk, provision may be made for the sensor target to be an integral part of the end disk. In other words, provision may be made for the sensor target to be formed in the end disk. It is therefore conceivable for the sensor target and the end disk to be formed and/or produced in one piece.

Another embodiment of the invention is that the end disk is formed from a metal, such as from aluminium. In this way, the end disk and the sensor target is produced inexpensively and in a weight-reducing manner.

According to another refinement of the invention, provision is made for the electric machine to have a stator with a stator winding head, and for a temperature sensor to be arranged on the sensor board and/or to be electrically conductively connected thereto, wherein the temperature sensor is in thermal contact with the stator winding head. Thermal contact of the temperature sensor with the stator winding head may be understood to refer to a contact-free arrangement of the temperature sensor with respect to the stator winding head or an indirect or direct physical contacting of the temperature sensor with the stator winding head. In the case of a contact-free arrangement of the temperature sensor with respect to the stator winding head, the thermal contact is effected via the air between the temperature sensor and the stator winding head. In order to increase the accuracy of the temperature detection, the temperature sensor is in physical contact with the stator winding head either directly or indirectly, that is to say via a connecting element. Due to the specific arrangement of the temperature sensor on the sensor board, the temperature of the electric machine is detected in a simple and/or space-saving manner. Any rotor scaling of the rotor in terms of its length has no influence on the position of the temperature sensor. Thus, the selected arrangement of the temperature sensor makes it possible to reduce the interface influence when the power of the electric machine is changed. In addition, the parts costs may be reduced as a result of the temperature sensor integrated on the sensor board.

In this context, a refinement of the invention provides for the temperature sensor to be pressed onto the stator winding head by way of a spring element. In this way, reliable, self-adjusting and permanent thermal contacting of the temperature sensor on the stator winding head is provided.

The invention also relates to a motor vehicle with the integrated axle drive according to the invention. The motor vehicle is an at least partially electrically driven motor vehicle. It is therefore also conceivable for the motor vehicle to be completely electrically driven. The axle drive sits in the drive train of the motor vehicle and is configured to drive the motor vehicle.

Further features and advantages of the present invention will emerge from the following exemplary embodiments. The exemplary embodiments are to be understood not as restrictive, but rather as examples. They are intended to enable a person skilled in the art to implement the invention. The applicant reserves the right to make one and/or more of the features disclosed in the exemplary embodiments or to include such features described herein. The exemplary embodiments are discussed in more detail with reference to drawings.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

In the drawings:

FIG. 1 shows a section through an integrated axle drive;

FIG. 2 shows a section through the integrated axle drive, a temperature sensor for detecting a stator temperature being integrated in a rotor position sensor for detecting a rotor position;

FIG. 3 shows a detail of a three-dimensional view of a rotor in the region of an end disk with an integrated sensor target;

FIG. 4 shows a motor vehicle with the integrated axle drive.

### DETAILED DESCRIPTION OF THE PREFERRED EMBODIMENTS

The following description of the preferred embodiment(s) is merely exemplary in nature and is in no way intended to limit the invention, its application, or uses.

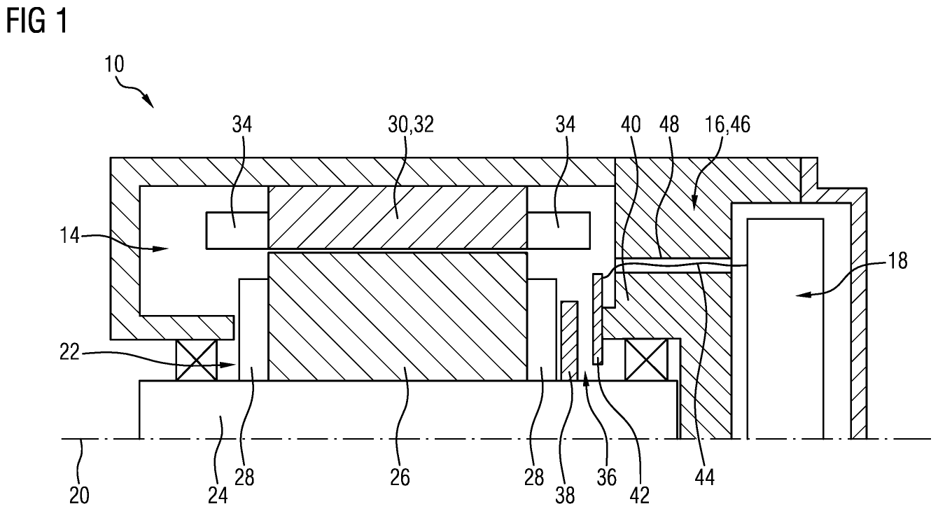

FIG. 1 shows a section through an integrated axle drive 10 for an at least partially electrically driven motor vehicle 12. The integrated axle drive 10 has an electric machine 14, a transmission 16 and an inverter 18.

The electric machine 14 includes a rotor 22 which is mounted so as to be rotatable about a rotor axis 20. The rotor 22 has a rotor shaft 24 with a laminated core 26 arranged on the rotor shaft 24. The laminated core 26 is braced in the axial direction of the rotor 22 by way of end disks 28. Furthermore, the electric machine 14 has a stator 30 which is arranged spaced apart from the rotor 22 by way of an air gap in the radial direction of the rotor 22. A winding of the stator 30 is guided beyond a laminated stator core 32 at the end side and is formed into a stator winding head 34.

The rotor shaft 24 of the rotor 22 is mechanically coupled to the transmission 16 (not shown); the transmission 16 is connected directly to the axle shafts of the motor vehicle 12.

The inverter 18 is arranged on a side of the transmission 16 facing away from the electric machine 14 and is electrically conductively connected to the electric machine 14. In this way, a compact, integrated axle drive 10 in a multi-part housing is specified.

Furthermore, provision is made for the integrated axle drive 10 to have a rotor position sensor 36. In the exemplary embodiment, the rotor position sensor 36 is in the form of an inductive sensor. The inductive rotor position sensor 36 includes a sensor target 38 which is arranged on the rotor 22, in this embodiment on the rotor shaft 24, in a rotationally fixed manner and a sensor board 42 which is arranged, with an air gap to the sensor target 38, on an end shield 40 of the electric machine 14. The end shield 40 carrying the sensor board 42 is arranged between the transmission 16 and the rotor 22 or between the transmission 16 and the electric machine 14. In other words, the end shield 40 may be in the form of an intermediate wall between the transmission 16, such as a transmission chamber for accommodating the gear wheels of the transmission, and the electric machine 14. The sensor board 42 is electrically conductively connected to the inverter 18 by way of a cable 44, which may also be referred to as a signal line. Provision is in this case made for a cable leadthrough 48 which is separated from the actual transmission mount or transmission chamber in a media-tight manner and through which the cable 44 is guided between the inverter 18 and the sensor board 42 to be formed within the transmission housing 46. In other words, the cable 44 is not guided through the actual oil-filled transmission chamber having the transmission gear wheels, but rather through a cable leadthrough 48 which is separated from the transmission chamber in a media-tight manner. In this way, the external influences on the cable 44 and its connector are reduced, as a result of which the longevity of the electrical connection between the inverter 18 and the sensor board 42 is increased. In addition, the costs of the cable 44 are reduced, since it is possible to dispense with an increased media-tightness of the cable 44 and/or the connector. Furthermore, due to the direct electrical connection between the sensor board 42 and the inverter 18, the electromagnetic influences on the cable 44 are reduced, such that the sensor positioning has increased accuracy. In addition, the selected position of the rotor position sensor 36 between the electric machine 14 and the transmission 16 has no influence on rotor length scaling in order to increase or reduce the power of the electric machine 14. In this way, the selected arrangement of the rotor position sensor 36 reduces the interface influence when the power of the electric machine 14 is changed.

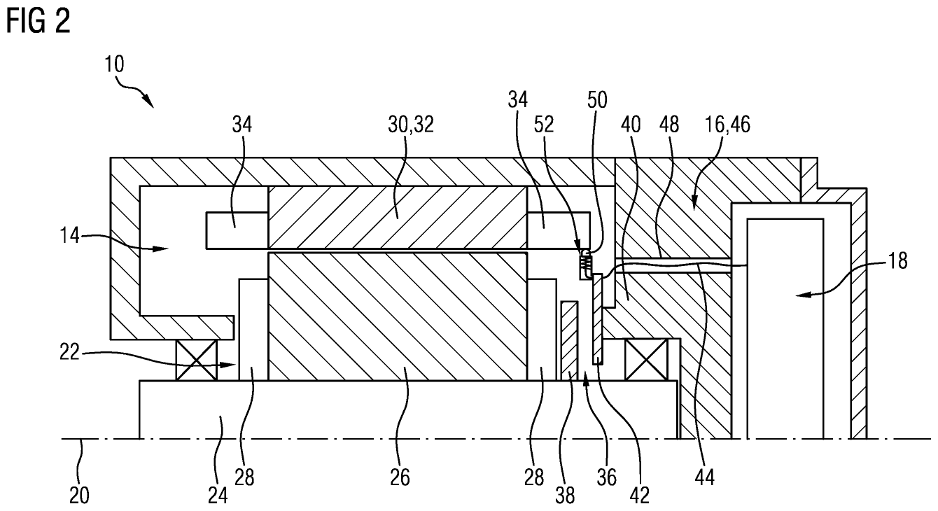

FIG. 2 shows a section through the already integrated axle drive 10 from FIG. 1. In contrast to FIG. 1, the integrated axle drive 10 shown in FIG. 2 has a rotor position sensor 36, a temperature sensor 50 being arranged on the sensor board 42. The temperature sensor 50 is pressed against the stator winding head 34 of the stator 30 by way of a spring element 52. In this way, reliable, self-adjusting and permanent thermal contacting of the temperature sensor 50 on the stator winding head 34 may be provided. In addition, parts costs of the integrated axle drive 10 may be reduced as a result of the temperature sensor 50 integrated on the sensor board 42. Moreover, the selected arrangement of the temperature sensor 50 makes it possible to reduce the interface influence when the power of the electric machine 14 is changed, since the position of the temperature sensor 50 has no influence on the rotor length.

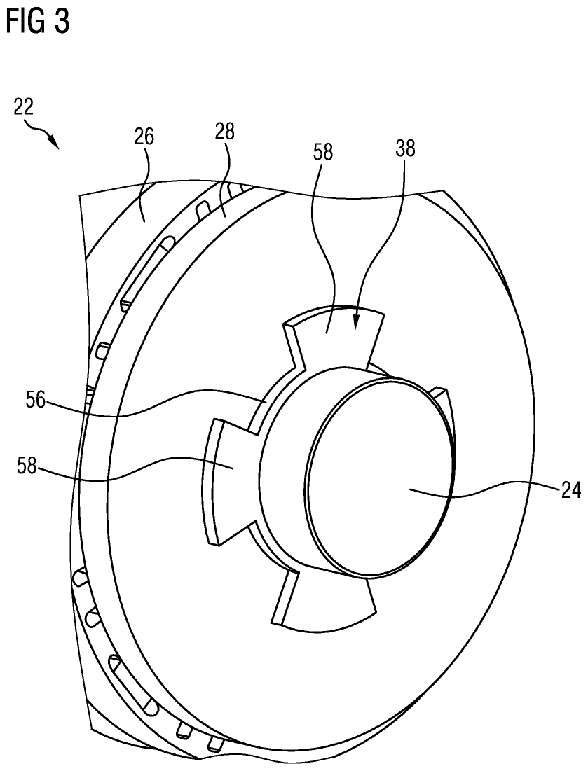

FIG. 3 shows a detail of a three-dimensional view of the rotor 22 in the region of the end disk 28. The sensor target 38 is integrated into the end disk 28 and includes a circular ring 56 with a plurality of portions 58 and/or projections which are directed outward in the radial direction of the rotor 22.

In other words, the end disk 28 and the sensor target 38 are formed in one piece. In the present case, the end disk 28 and the sensor target 38 are formed from aluminum. The integral design of the end disk 28 and the sensor target 38 makes it possible to reduce the installation space in the axial direction of the rotor 22. The weight of the rotor 22 may be reduced by the choice of material. Due to the integral construction of the end disk 28 and the sensor target 38, working steps are reduced and thus production costs of the axle drive 10 are also reduced.

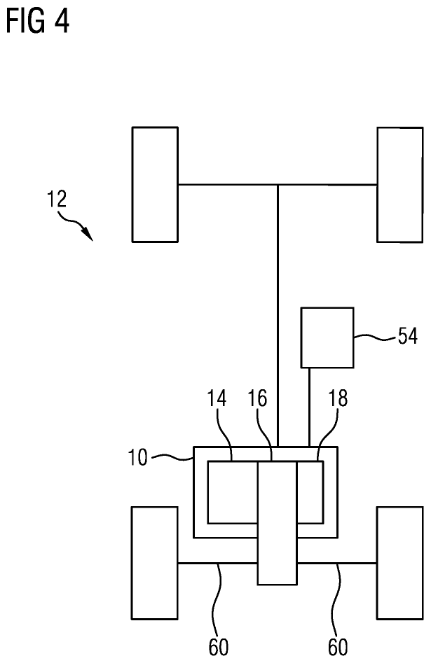

FIG. 4 shows a schematic plan view of an at least partially electrically driven motor vehicle 12. The motor vehicle 12 has the integrated axle drive 10 which is electrically conductively connected to a battery 54 of the motor vehicle 12. The transmission 16 is coupled to the axle shafts 60 of the motor vehicle 12.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An integrated axle drive for an at least partially electrically driven motor vehicle, comprising:
an electric machine, further comprising:
a rotor which is mounted so as to be rotatable about a rotor axis;
a transmission which is coupled to the electric machine;
an inverter which is arranged on the transmission and is electrically conductively connected to the electric machine, and the transmission is arranged between the electric machine and the inverter;
a multi-part rotor position sensor, further comprising:
a sensor target which is arranged and/or formed on the rotor in a rotationally fixed manner;
an end shield; and
a sensor board which is arranged, with an air gap to the sensor target, on the end shield of the electric machine;
wherein the end shield carrying the sensor board is arranged between the transmission and the rotor, and the sensor board is electrically conductively connected to the inverter.

2. The integrated axle drive of claim 1, further comprising:
a cable for the electrically conductive connection of the inverter to the sensor board;
wherein the cable is guided through a transmission housing of the transmission.

3. The integrated axle drive of claim 2, further comprising:
a cable leadthrough formed within the transmission housing such that the cable leadthrough is separated from a transmission chamber of the transmission in a media-tight manner;
wherein the cable is guided through the cable leadthrough between the inverter and the sensor board.

4. The integrated axle drive of claim 1, wherein the sensor board is arranged on the end shield in a force-fitting and/or materially bonded manner.

5. The integrated axle drive of claim 1, the rotor further comprising a rotor shaft, wherein the sensor target is arranged on the rotor shaft in a rotationally fixed manner.

6. The integrated axle drive of claim 1, characterized in that the rotor has at least one end disk, and the sensor target is arranged on the end disk or is an integral part of the end disk.

7. The integrated axle drive of claim 6, wherein the end disk is formed from a metal.

8. The integrated axle drive of claim 7, wherein the end disk is formed from aluminum.

9. The integrated axle drive of claim 1, the electric machine further comprising:
a stator with a stator winding head, the stator arranged spaced apart from the rotor; and
a temperature sensor arranged on the sensor board and/or electrically conductively connected thereto;
wherein the temperature sensor is in thermal contact with the stator winding head.

10. The integrated axle drive of claim 9, wherein the temperature sensor is pressed onto the stator winding head by way of a spring element .

11. The integrated axle drive of claim 1, the multi-part rotor position sensor further comprising an inductive sensor.

12. A motor vehicle comprising:
an integrated axle drive, further comprising:
an electric machine, further comprising:
a rotor which is mounted so as to be rotatable about a rotor axis;
a transmission which is coupled to the electric machine;
an inverter which is arranged on the transmission and is electrically conductively connected to the electric machine, and the transmission is arranged between the electric machine and the inverter;
a multi-part rotor position sensor, further comprising:
a sensor target which is arranged and/or formed on the rotor in a rotationally fixed manner;
an end shield; and
a sensor board which is arranged, with an air gap to the sensor target, on the end shield of the electric machine;
wherein the end shield carrying the sensor board is arranged between the transmission and the rotor, and the sensor board is electrically conductively connected to the inverter.
